(19) United States
(12) Patent Application Publication
(10) Pub. No.: US 2026/0105555 A1
(43) Pub. Date: Apr. 16, 2026

(54) PROPOSAL GENERATION DEVICE, LEARNING DEVICE, PROPOSAL GENERATION METHOD, LEARNING METHOD, AND PROGRAM

(71) Applicants: NEC Corporation, Tokyo (JP); NATIONAL INSTITUTE OF ADVANCED INDUSTRIAL SCIENCE AND TECHNOLOGY, Tokyo (JP)

(72) Inventors: Ryota HIGA, Tsukuba-shi (JP); hiroyasu Yoshino, Tsukuba-shi (JP); Katsuhide Fujita, Tsukuba-shi (JP)

(73) Assignees: NEC Corporation, Tokyo (JP); NATIONAL INSTITUTE OF ADVANCED INDUSTRIAL SCIENCE AND TECHNOLOGY, Tokyo (JP)

(21) Appl. No.: 19/354,952

(22) Filed: Oct. 10, 2025

(30) Foreign Application Priority Data
Oct. 15, 2024 (JP) 2024-180394

(51) Int. Cl. G06Q 50/18

(52) U.S. Cl. CPC G06Q 50/188

(57) ABSTRACT

A proposal generation device converts, for each of one or more items defined as an item of a proposal target, each of all possible bids each of which is a bid being a combination of the item and a single proposal option among proposal options that are selectable proposal contents for the item, into a numerical vector capable of identifying the bids. The proposal generation device converts each bid included in a history of bids in a negotiation into a numerical vector capable of identifying the bid. The proposal generation device determines, using the numerical vector into which each of all possible bids has been converted, and the numerical vector into which each bid included in the history of bids has been converted, a bid to be proposed to a negotiation opponent, from among all possible bids.

### CROSS-REFERENCE TO RELATED APPLICATIONS

The present application claims priority to Japanese Patent Application No. 2024-180394, filed Oct. 15, 2024, the contents of which are incorporated herein by reference.

### BACKGROUND

### Technical Field

The present disclosure relates to a proposal generation device, a learning device, a proposal generation method, a learning method, and a program.

### Background Art

A proposal in a negotiation is sometimes determined using a model.

For example, in the method described in Japanese Unexamined Patent Application, First Publication No. 2020-013568 (hereinafter referred to as Patent Document 1), it is described that a negotiation agent and an opponent agent are simultaneously trained using reinforcement learning so as to converse using an interpretable sequence of bits. In the method described in Patent Document 1, the negotiation agent and the opponent agent conduct several rounds of negotiation levels with each other, and then learn to cooperate with each other based on outcomes that serve as a reward function.

### SUMMARY

It is preferable that the same model can be used in common for negotiations in different fields.

An example object of the present disclosure is to provide a proposal generation device, a learning device, a proposal generation method, a learning method, and a program that can solve the problem described above.

According to a first example aspect of the present disclosure, a proposal generation device includes: a memory configured to store instructions; and a processor configured to execute the instructions to: convert, for each of one or more items defined as an item of a proposal target, each of all possible bids each of which is a bid being a combination of the item and a single proposal option among proposal options that are selectable proposal contents for the item, into a numerical vector capable of identifying the bids; convert each bid included in a history of bids in a negotiation into a numerical vector capable of identifying the bid; and determine, using the numerical vector into which each of all possible bids has been converted, and the numerical vector into which each bid included in the history of bids has been converted, a bid to be proposed to a negotiation opponent, from among all possible bids.

According to a second example aspect of the present disclosure, a learning device includes: a memory configured to store instructions; and a processor configured to execute the instructions to: convert, for each of one or more items defined as an item of a proposal target, each of all possible bids each of which is a bid being a combination of the item and a single proposal option among proposal options that are selectable proposal contents for the item, into a numerical vector capable of identifying the bids; convert each bid included in a history of bids in a negotiation into a numerical vector capable of identifying the bid; determine, using the numerical vector into which each of all possible bids has been converted, and the numerical vector into which each bid included in the history of bids has been converted, a bid to be proposed to a negotiation opponent, from among all possible bids; and learn a method of determining the bid to be proposed to the negotiation opponent.

According to a third example aspect of the present disclosure, a proposal generation method is executed by a computer, and includes: converting, for each of one or more items defined as an item of a proposal target, each of all possible bids each of which is a bid being a combination of the item and a single proposal option among proposal options that are selectable proposal contents for the item, into a numerical vector capable of identifying the bids; converting each bid included in a history of bids in a negotiation into a numerical vector capable of identifying the bid; and determining, using the numerical vector into which each of all possible bids has been converted, and the numerical vector into which each bid included in the history of bids has been converted, a bid to be proposed to a negotiation opponent, from among all possible bids.

According to a fourth example aspect of the present disclosure, a learning method is executed by a computer, and includes: converting, for each of one or more items defined as an item of a proposal target, each of all possible bids each of which is a bid being a combination of the item and a single proposal option among proposal options that are selectable proposal contents for the item, into a numerical vector capable of identifying the bids; converting each bid included in a history of bids in a negotiation into a numerical vector capable of identifying the bid; determining, using the numerical vector into which each of all possible bids has been converted, and the numerical vector into which each bid included in the history of bids has been converted, a bid to be proposed to a negotiation opponent, from among all possible bids; and learning a method of determining the bid to be proposed to the negotiation opponent.

According to a fifth example aspect of the present disclosure, a program causes a computer to execute: converting, for each of one or more items defined as an item of a proposal target, each of all possible bids each of which is a bid being a combination of the item and a single proposal option among proposal options that are selectable proposal contents for the item, into a numerical vector capable of identifying the bids; converting each bid included in a history of bids in a negotiation into a numerical vector capable of identifying the bid; and determining, using the numerical vector into which each of all possible bids has been converted, and the numerical vector into which each bid included in the history of bids has been converted, a bid to be proposed to a negotiation opponent, from among all possible bids.

According to a sixth example aspect of the present disclosure, a program causes a computer to execute: converting, for each of one or more items defined as an item of a proposal target, each of all possible bids each of which is a bid being a combination of the item and a single proposal option among proposal options that are selectable proposal contents for the item, into a numerical vector capable of identifying the bids; converting each bid included in a history of bids in a negotiation into a numerical vector capable of identifying the bid; determining, using the numerical vector into which each of all possible bids has been converted, and the numerical vector into which each bid included in the history of bids has been converted, a bid to be proposed to a negotiation opponent, from among all possible bids; and learning a method of determining the bid to be proposed to the negotiation opponent.

According to an example aspect of the present disclosure, the same model can be used in common for negotiations in different fields.

### BRIEF DESCRIPTION OF THE DRAWINGS

FIG. 1 is a diagram showing an example of a configuration of a learning device according to at least one example embodiment.

FIG. 2 is a diagram showing an example of a configuration of a bid selection unit according to at least one example embodiment.

FIG. 3 is a diagram showing an example of data input and output in the learning device according to at least one example embodiment.

FIG. 4 is a diagram showing an example of a configuration of a proposal generation device according to at least one example embodiment.

FIG. 5 is a diagram showing an example of data input and output in the proposal generation device according to at least one example embodiment.

FIG. 6 is a diagram showing a result of an experiment performed using a proposal generation device according to at least one example embodiment.

FIG. 7 is a diagram showing an example of a configuration of a proposal generation device according to at least one example embodiment.

FIG. 8 is a diagram showing an example of a configuration of a learning device according to at least one example embodiment.

FIG. 9 is a diagram showing an example of a processing procedure of a proposal generation method according to at least one example embodiment.

FIG. 10 is a diagram showing an example of a processing procedure of a learning method according to at least one example embodiment.

FIG. 11 is a schematic block diagram showing a configuration of a computer according to at least one example embodiment.

### EXAMPLE EMBODIMENT

Hereinafter, example embodiments will be described with reference to the drawings.

### First Example Embodiment

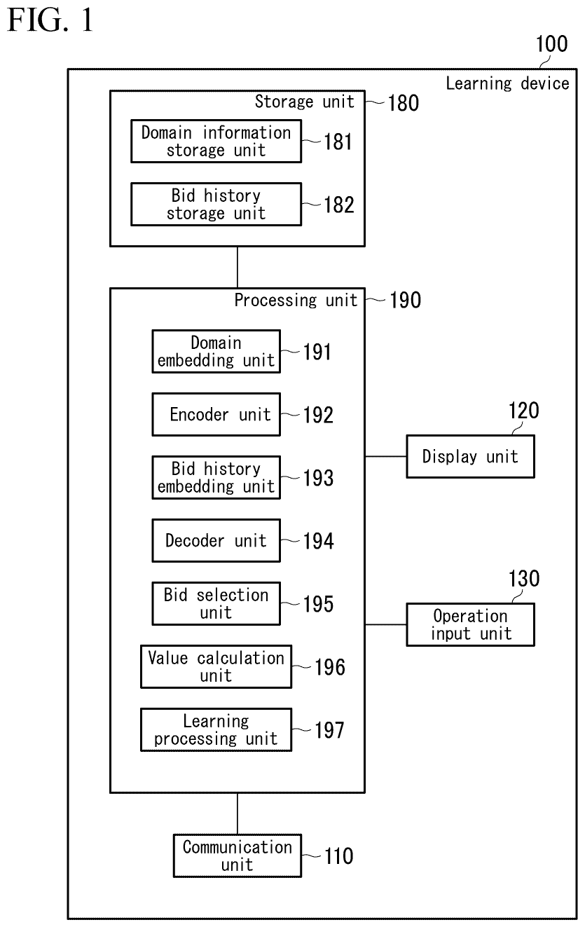

FIG. 1 is a diagram showing an example of a configuration of a learning device according to at least one example embodiment.

In the configuration shown in FIG. 1, the learning device 100 includes a communication unit 110, a display unit 120, an operation input unit 130, a storage unit 180, and a processing unit 190. The storage unit 180 includes a domain information storage unit 181 and a bid history storage unit 182. The processing unit 190 includes a domain embedding unit 191, an encoder unit 192, a bid history embedding unit 193, a decoder unit 194, a bid selection unit 195, a value calculation unit 196, and a learning processing unit 197.

The learning device 100 performs learning for generating a proposal in a negotiation. The learning referred to here is the adjustment of parameter values of a machine learning model. Learning can also be referred to as training.

The learning device may be configured using a computer such as a workstation (WS) or a personal computer (PC).

It is assumed that the learning device 100 conducts a negotiation within the following framework.

A proposal in a negotiation is also referred to as a bid.

Here, the negotiation is assumed to be between two parties. Of the two negotiating parties, the learning device 100 side is referred to as “Self”, and the other negotiating party is referred to as “Opponent”. In a negotiation, it is assumed that Self and Opponent alternatingly make bids.

Here, it is assumed that Opponent is also a device, and is referred to as an opponent agent device. However, Opponent may also be a person.

A single turn of bidding by each of Self and Opponent is considered a single step, and the combination of Self's bid and Opponent's bid is also referred to as the bids of a single step. Of the bids in a single step, both Self's bid and Opponent's bid are referred to as a single bid.

Hereinafter, time will be indicated by time steps, and a bid made in the tth step is also referred to as time t or step t. Here, t is an integer such that t≥1.

A single bid is assumed to be a proposal for n items. Here, n is an integer such that n≥1. The proposal target items (items that are the target of a proposal) are also referred to as issues.

The set I of proposal target items is represented as in expression (1).

$$\begin{matrix}( Expression 1 ) & \\ I = \{ {I}_{1} , {I}_{2} , … , {I}_{n} \} & ( 1 )\end{matrix}$$

I₁, I₂, . . . , Iₙ each represent a proposal target item.

For each proposal target item, one of kᵢ types of proposal contents is selected. Here, i is an integer that identifies a proposal target item, such that 1≤i≤n. The selectable proposal contents are also referred to as options or proposal options.

The set Vᵢ of proposal options is represented as in expression (2).

$$\begin{matrix}( Expression 2 ) & \\ {V}_{i} = \{ {v}_{1}^{i} , {v}_{2}^{i} , … , {v}_{{k}_{i}}^{i} \} & ( 2 )\end{matrix}$$

Vⁱ₁, Vⁱ₂, . . . , Vⁱₖᵢ each represent a proposal option.

An individual bid (a single bid) ω is shown as in expression (3).

$$\begin{matrix}( Expression 3 ) & \\ ω = ( {v}_{{c}_{1}}^{1} , {v}_{{c}_{2}}^{2} , … , {v}_{{c}_{n}}^{n} ) & ( 3 )\end{matrix}$$

cᵢ is an integer indicating the proposal option that has been selected for the ith proposal target item, such that 1≤cᵢ≤kᵢ.

The set of bids (the set of combinations of proposal options selectable in a single bid) Ω is represented as in expression (4).

$$\begin{matrix}( Expression 4 ) & \\ Ω = \{ ( {v}_{{c}_{1}}^{1} , {v}_{{c}_{2}}^{2} , … , {v}_{{c}_{n}}^{n} ) \vert {c}_{i} ∈ \{ 1 , 2 , … , {k}_{i} \} , i ∈ \{ 1 , 2 , … , n \} \} & ( 4 )\end{matrix}$$

It is assumed that the learning device 100 knows the set of bids Q.

It is assumed that the learning device 100 performs reinforcement learning.

The reinforcement learning referred to here is machine learning that learns a policy, which is an action rule of an agent that performs an action with respect to a certain environment, based on a state of the environment and a reward representing an evaluation of the state or action.

In the learning by the learning device 100, the combination of the set of bids and an opponent agent device can be regarded as the environment. Self's bid (the bid made by the learning device 100) can be regarded as an action, and the generation rules for Self's bid can be regarded as a policy. Furthermore, it is assumed that the opponent agent device has a state, and the state can be regarded as a state of the reinforcement learning.

Within the framework of a set of bids, the state of the opponent agent device transitions in response to the bid made by the learning device 100. The opponent agent device makes a bid according to the state and the bid made by the learning device 100.

Moreover, the negotiation result can be regarded as a reward. In the learning by the learning device 100, it is assumed that a reward is obtained according to the negotiation result at the end of the negotiation.

As described above, Self's bid can be regarded as an action, and the set of bids Ω can be regarded as the set of actions that the learning device 100 can take. The set of actions A is represented as in expression (5).

$$\begin{matrix}( Expression 5 ) & \\ A = Ω = \{ {ω}_{1} , {ω}_{2} , … , {ω}_{\vert Ω \vert} \} & ( 5 )\end{matrix}$$

|Ω| represents the number of elements in the set of bids Q. Therefore, |Ω| indicates the number of combinations of proposal options that can be selected in a single bid.

In addition, it is assumed that the learning device 100 does not know the state of the opponent agent device. Therefore, in the learning device 100, it is assumed that the state of reinforcement learning is represented by the history of bids of the most recent previous single step. The state sₜ at time t is represented as in expression (6).

$$\begin{matrix}( Expression 6 ) & \\ {s}_{t} = \{ {ω}_{t - 1}^{s} , {ω}_{t - 1}^{o} \} & ( 6 )\end{matrix}$$

ω^{s}ₜ represents Self's bid at time t. ω^{o}ₜ represents Opponent's bid at time t.

Also, as a reward, for example, the reward shown in expression (7) can be used.

$$\begin{matrix}( Expression 7 ) & \\ {r}_{t} = \{ \begin{matrix}{U}_{s} ( {ω}_{a} ) : When agreement is reached \\ 0 : During negotiation \\ - 1 : Agreement was not reached\end{matrix} & ( 7 )\end{matrix}$$

ωₐ represents an agreed-upon bid. For example, if an agreement is reached with the bids at time t, then ωₐ=(ω^{s}ₜ, ω^{o}ₜ).

The function Uₛ outputs an evaluation value for the agreed-upon bid ωₐ. As the function Uₛ, various functions that output a larger value as the evaluation of the bid ωₐ improves can be used. However, the reward used by the learning device 100 is not limited to a specific type.

The policy function π_{θ} is represented as in expression (8).

$$\begin{matrix}( Expression 8 ) & \\ {π}_{θ} ( {ω}_{t}^{s} \vert {s}_{1 : t} ) & ( 8 )\end{matrix}$$

Here, θ represents a parameter of the policy function π_{θ}.

s_{1:t} represents the history of states from time 1 to t. The policy function π_{θ} determines Self's bid ω^{s}ₜ at time t based on the history of states from time 1 to t. Therefore, the policy function π_{θ} determines Self's bid ω^{s}ₜ at time t based on the history of bids from time 1 to t−1.

The policy function π_{θ} corresponds to a machine learning model. The parameter θ corresponds to a parameter to be learned.

The state transition function T is represented as in expression (9).

$$\begin{matrix}( Expression 9 ) & \\ T = p ( {s}_{t + 1} \vert {a}_{t} , {s}_{t} ) = p ( {ω}_{o}^{t} \vert {a}_{t} , {s}_{t} ; {π}_{i , j} ) & ( 9 )\end{matrix}$$

π_{i,j} represents Opponent's policy (Opponent's negotiation strategy).

As shown in expression (9), in response to Self's bid ω^{s}ₜ at time t, Opponent's bid ω^{o}ₜ is stochastically selected according to Opponent's negotiation strategy.

However, it is assumed that the learning device 100 does not know the state transition probability p. The learning device 100 can be regarded as learning a policy (a negotiation strategy for determining Self's bid) for opponents that adopt various negotiation strategies through learning.

The expected value of the reward E_{πθ,T} under the policy function π_{θ} and the state transition function T is represented as in expression (10).

$$\begin{matrix}( Expression 10 ) & \\ {E}_{{π}_{θ} , T} ( \sum {r}_{t} ) & ( 10 )\end{matrix}$$

The expected value of a reward is also referred to as an expected reward.

Here, in cases such as when the reward is represented by expression (7), it is conceivable that the learning device 100 does not know the reward during the negotiation. Therefore, it is assumed that the learning device 100 calculates a value using the value function Ve shown in expression (11).

$$\begin{matrix}( Expression 11 ) & \\ {V}_{θ} ( {s}_{1 : t} ) & ( 11 )\end{matrix}$$

Here, θ represents a parameter of the value function.

s_{1:t} represents the history of states from time 1 tot. The history of states sit from time 1 to t, is represented as in expression (12).

$$\begin{matrix}( Expression 12 ) & \\ {s}_{1 : t} = ( {ω}_{1}^{s} , {ω}_{1}^{o} , {ω}_{2}^{s} , {ω}_{2}^{o} , … , {ω}_{t - 1}^{s} , {ω}_{t - 1}^{o} ) & ( 12 )\end{matrix}$$

As described above, in the learning device 100, the state of reinforcement learning is represented by the history of bids of the most recent previous single step. Therefore, the history of bids from time 1 to t is used as the history of states from time 1 to t. The history of states sin is also referred to as the history of bids s_{1:t}.

The value function Ve calculates the value s_{1:t} for the history of states from time 1 to t. Therefore, the value (the value of the value function) V_{θ}(s_{1:t}) at time t can be regarded as indicating the evaluation of the history of bids from time 1 to t.

The learning device 100 performs learning of the value function V_{θ} such that the value V_{θ}(s_{1:t}) at the end of the negotiation approximates the expected reward E_{πθ,T}(Σrₜ) at the end of the negotiation.

The communication unit 110 performs communication with other devices. For example, the communication unit 110 transmits Self's bid to the opponent agent device. Also, the communication unit 110 receives Opponent's bid from the opponent agent device.

The display unit 120 includes, for example, a display screen such as a liquid crystal panel or an LED (Light Emitting Diode) panel, and displays various images. For example, the display unit 120 may display various information related to the negotiation, such as the history of bids. Also, the display unit 120 may display various information relating to learning, such as displaying the number of negotiation executions as an indication of the progress of learning.

The operation input unit 130 includes input devices such as a keyboard and a mouse, and accepts user operations. For example, the operation input unit 130 may accept user operations that perform various settings relating to learning, such as the learning rate and discount rate.

The storage unit 180 stores various types of data. The storage unit 180 is configured by using a storage device included in the learning device 100.

The domain information storage unit 181 stores information indicating the domain of the negotiation. The information indicating the domain of the negotiation is also referred to as domain information.

The domain of negotiation referred to here is the field of application of the negotiation.

The domain information storage unit 181 stores the set of bids Ω as domain information. It is conceivable that the number of proposal target items, the number of proposal options per proposal target item, and the values of the proposal options (contents of the proposal options) may differ depending on the domain of a negotiation.

Also, by using the set of bids Ω as domain information, it is expected to be possible to determine whether two negotiations are in similar domains (or in the same domain) or in different domains, without having to explicitly distinguish the domains to which the negotiations belong.

The bid history storage unit 182 stores the history of bids. Specifically, the bid history storage unit 182 stores the history of bids s_{1:t} at time t.

The processing unit 190 performs various processing that controls each unit of the learning device 100. The functions of the control unit 190 are executed, for example, as a result of a CPU (Central Processing Unit) included in the learning device 100 reading and executing a program from the storage unit 180.

The domain embedding unit 191 converts information indicating the domain of a negotiation into a numerical vector (a vector having numerical values as elements). The domain embedding unit 191 corresponds to an example of a domain embedding means.

Specifically, the domain embedding unit 191 converts the set of bids Ω into a numerical vector. For example, the domain embedding unit 191 may convert the set of bids Ω into a numerical vector based on expression (13).

$$\begin{matrix}( Expression 13 ) & \\ F ( Ω ) = \{ f ( {I}_{i} ) + f ( {v}_{{c}_{i}}^{i} ) \vert {c}_{i} ∈ \{ 1 , 2 , … , {k}_{i} \} , i ∈ \{ 1 , 2 , … , n \} \} & ( 13 )\end{matrix}$$

The function F is a function that converts the set of bids Ω into a numerical vector.

However, the output of the function F may be treated as a vector, or may be treated as a set. That is to say, the elements of the output of the function F may or may not be ordered. It is sufficient if a degree of similarity between the outputs of the function F can be calculated.

The function f is a function that converts each of a proposal target item Iᵢ and a proposal option vⁱ_{ci} into a numerical value. The function f outputs a numerical value that can uniquely identify the input, irrespective of whether a proposal target item Iᵢ or a proposal option vⁱ_{ci} is input. That is, the function f maps the input to a numerical value in a one-to-one mapping. The function f is also referred to as an embedding function.

As the function f, various functions that map both a proposal target item Iᵢ and a proposal option vⁱ_{ci} to a numerical value in a one-to-one mapping can be used.

In expression (13), the function F takes the linear sum of f(Iᵢ) and f(vⁱ_{ci}). The inventor of the present application has found that a linear sum as in expression (13) can be used as the function F.

The domain embedding unit 191 converts each bid included in the set of bids Ω into a numerical vector that is capable of identifying the bid by converting the combination of a proposal target item Iᵢ and a proposal option vⁱ_{c} into a numerical value by calculating the value of f(Iᵢ)+f(vⁱ_{ci}), and as a result, can be considered to convert the set of bids Ω into a numerical vector.

The encoder unit 192 converts the numerical vector output by the domain embedding unit 191 into a numerical vector that takes attention into account.

In particular, the encoder unit 192 accepts an input of variable-length data. As a result, the learning device 100 is capable of determining Self's bid and performing learning corresponding to various cases of the number of proposal target items and the number of proposal options. This allows the learning device 100 to handle various domains.

As the encoder unit 192, an encoder in a known foundation model may be used.

The bid history embedding unit 193 converts the history of bids into a numerical vector using the function f. The bid history embedding unit 193 corresponds to an example of a bid embedding means.

For example, the bid history embedding unit 193 may convert the history of bids into a numerical vector based on expression (14).

$$\begin{matrix}( Expression 14 ) & \\ F ( {s}_{1 : t} ) = \{ ( f ( {I}_{1} ) + f ( {v}_{{c}_{1}}^{1 ; {j}_{s}} ) , … , f ( {I}_{n} ) + f ( {v}_{{c}_{n}}^{n ; {j}_{s}} ) ) , \\ ( f ( {I}_{1} ) + f ( {v}_{{c}_{1}}^{1 ; {j}_{o}} ) , … , f ( {I}_{n} ) + f ( {v}_{{c}_{n}}^{n ; {j}_{o}} ) ) \vert j ∈ \{ 0 , 1 , 2 , … , t - 1 \} \} & ( 14 )\end{matrix}$$

v_{c}^{i:js} represents the proposal content for the ith item in Self's bid at time j. The c in v_{c}^{i:js} represents the cth proposal option among the proposal options.

v_{c}^{i:jo} represents the proposal content for the ith item in Opponent's bid at time j. The c in v_{c}^{i:jo} represents the cth proposal option among the proposal options.

The bid history embedding unit 193 converts each bid included in the history of bids s_{1:t} into a numerical vector capable of identifying the bid using the same method as the method by which the domain embedding unit 191 converts bids into a numerical vector, and as a result, can be considered to convert the history of bids s_{1:t} into a numerical vector.

The decoder unit 194 performs a conversion with respect to the numerical vector output by the bid history embedding unit 193 using the numerical vector output by the encoder unit 192.

In particular, the decoder unit 194 accepts an input of variable-length data. As a result, the learning device 100 is capable of using a bid history of any length for the determination of Self's bid. In particular, the learning device 100 can use the entire history of bids of both Self's bids and Opponent's bids from the start of the negotiation to the present. In this respect, it is expected that the learning device 100 can perform learning of the determination method of Self's bid with high precision, and can determine Self's bid with high precision.

Here, performing the determination of a bid with high precision may mean that the obtained reward is large (the evaluation indicated by the reward is high). Performing the learning of the determination method of a bid with high precision may mean performing learning so as to determine a bid such that the obtained reward becomes large (such that the evaluation indicated by the reward is high).

As the decoder unit 194, a decoder in a known foundation model may be used.

The bid selection unit 195 determines Self's bid (the bid that Self presents to Opponent) using the numerical vector output by the decoder unit 194.

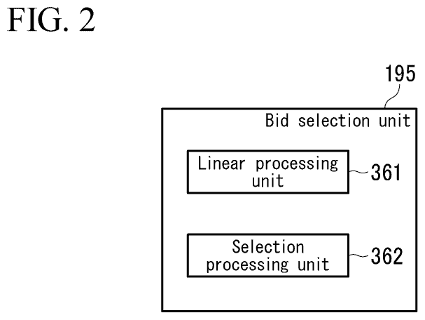

FIG. 2 is a diagram showing an example of the configuration of the bid selection unit 195. In the configuration shown in FIG. 2, the bid selection unit 195 includes a linear processing unit 361 and a selection processing unit 362.

The linear processing unit 361 calculates an evaluation value for each bid candidate based on the numerical vector output by the decoder unit 194.

The selection processing unit 362 selects the candidate with the best evaluation based on the evaluation value for each bid candidate output by the linear processing unit 361. The selection processing unit 362 may select the candidate with the largest evaluation value output by the linear processing unit 361 using a Softmax function.

The processing performed by the bid selection unit 195 can be regarded as being similar to the processing in the output layer of a neural network that performs class classification. The processing performed by the linear processing unit 361 can be regarded as processing that takes a fully connected combination of the element values of the numerical vector output by the decoder unit 194, and then calculates a likelihood for each bid candidate.

However, the configuration of the bid selection unit 195 is not limited to a specific configuration.

The combination of the encoder unit 192, the decoder unit 194, and the bid selection unit 195 corresponds to an example of a bid determination means.

The value calculation unit 196 inputs the output of the decoder unit 194 into the value function V_{θ} and calculates the value V_{θ}(s_{1:t}).

As the value function V_{θ} used by the value calculation unit 196, various value functions in known reinforcement learning can be used.

The learning processing unit 197 performs learning of the policy function π_{θ} and learning of the value function v_{θ}.

The learning processing unit 197 corresponds to an example of a learning processing means.

In terms of the learning of the policy function π_{θ}, the learning processing unit 197 performs learning of the policy function π_{θ} by reinforcement learning. The learning processing unit 197 may perform learning of the policy function π_{θ} using a known reinforcement learning method.

The bid selection unit 195 can also be regarded as a unit that configures the policy function π_{θ}. Alternatively, the combination of the bid history embedding unit 193, the decoder unit 194, and the bid selection unit 195 can also be regarded as units that configure the policy function π_{θ}.

In terms of the learning of the value function v_{θ}, the learning processing unit 197 performs learning of the value function V_{θ} such that the value V_{θ}(s_{1:t}) at the end of the negotiation approximates the expected reward E_{πθ,T}(Σrₜ) at the end of the negotiation. As the machine learning model that configure the value function V_{θ} and the learning method therefor, various types of machine learning models and learning methods that can bring the output of the machine learning model closer to a value indicated as a correct value can be used. For example, the value function V_{θ} may be configured using a neural network (NN), and the learning processing unit 197 may perform learning of the value function V_{θ} using backpropagation, but it is not limited to this.

The value calculation unit 196 can also be regarded as a unit that configures the value function V_{θ}. Alternatively, the combination of the bid history embedding unit 193, the decoder unit 194, and the value calculation unit 196 can also be regarded as units that configure the value function V_{θ}.

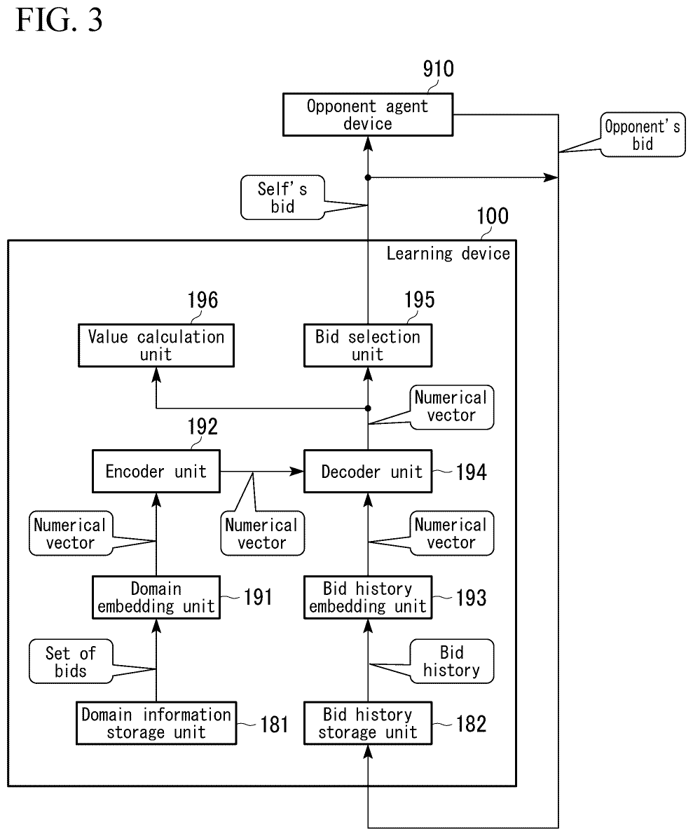

FIG. 3 is a diagram showing an example of data input and output in the learning device 100.

In the example of FIG. 3, the domain embedding unit 191 reads the set of bids Ω from the domain information storage unit 181, and then converts the set of bids Ω that has been read into a numerical vector. The domain embedding unit 191 outputs the numerical vector obtained by converting the set of bids Ω to the encoder unit 192.

The encoder unit 192 converts the numerical vector output by the domain embedding unit 191 into a numerical vector that takes attention into account. The encoder unit 192 outputs the numerical vector that takes attention into account to the decoder unit 194.

In a case where the set of bids does not change during the negotiation, the domain embedding unit 191 and the encoder unit 192 only need to perform the process once at the start of the negotiation. In a case where the set of bids may change during the negotiation, the domain embedding unit 191 and the encoder unit 192 may perform the process at the start of the negotiation and when the set of bids changes.

The bid history embedding unit 193 reads the history of bids s_{1:t} from the bid history storage unit 182, and then converts the history of bids s_{1:t} that has been read into a numerical vector. The bid history embedding unit 193 outputs the numerical vector obtained by converting the history of bids s_{1:t} to the decoder unit 194.

The decoder unit 194 performs a conversion with respect to the numerical vector output by the bid history embedding unit 193 using the numerical vector output by the encoder unit 192. The decoder unit 194 outputs the converted numerical vector to the bid selection unit 195 and the value calculation unit 196.

The bid selection unit 195 selects one of the bid candidates based on the numerical vector output by the decoder unit 194. The bid selection unit 195 transmits the selected bid as Self's bid to an opponent agent device 910 via the communication unit 110.

The opponent agent device 910 receives Self's bid, determines Opponent's bid, and transmits Opponent's bid that has been determined to the learning device 100.

In the learning device 100, the communication unit 110 receives Opponent's bid. The processing unit 190 updates the history of bids stored in the bid history storage unit 182 so as to add the combination of Self's bid, and Opponent's bid made in response thereto, to the history of bids.

The value calculation unit 196 calculates a value that approximately indicates the reward based on the numerical vector output by the decoder unit 194. The value calculated by the value calculation unit 196 can be regarded as an evaluation of the history of bids π_{1:t}.

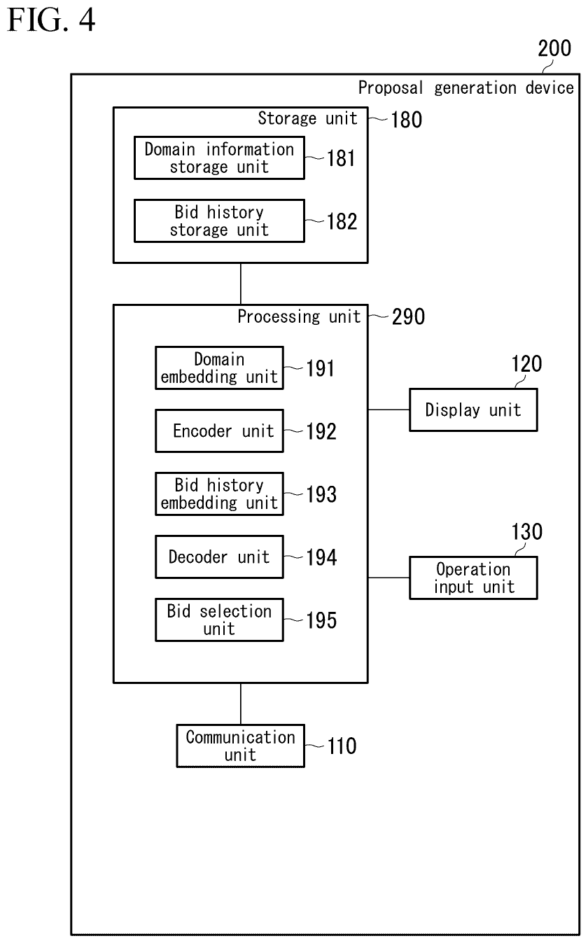

FIG. 4 is a diagram showing an example of a configuration of a proposal generation device according to at least one example embodiment. In the configuration shown in FIG. 4, the proposal generation device 200 includes a communication unit 110, a display unit 120, an operation input unit 130, a storage unit 180, and a processing unit 290. The storage unit 180 includes a domain information storage unit 181 and a bid history storage unit 182. The processing unit 290 includes a domain embedding unit 191, an encoder unit 192, a bid history embedding unit 193, a decoder unit 194, and a bid selection unit 195.

Of the units in FIG. 4, those units having the same functions as the units shown in FIG. 1 are designated by the same reference symbols (110, 120, 130, 180, 181, 182, 191, 192, 193, 194, and 195), and a detailed description will be omitted here.

In the proposal generation device 200, of the units provided in the processing unit 190 of the learning device 100, the processing unit 290 does not include the value calculation unit 196 and the learning processing unit 197. The proposal generation device 200 is the same as the learning device 100 in all other respects.

The learning device 100 that has been trained can be used as the proposal generation device 200. The proposal generation device 200 generates and outputs Self's bids in the same manner as the learning device 100. On the other hand, the proposal generation device 200 does not perform learning of the policy function π_{θ} and learning of the value function v_{θ}.

Here, of the two negotiating parties, the proposal generation device 200 side is referred to as “Self”, and the other negotiating party is referred to as “Opponent”.

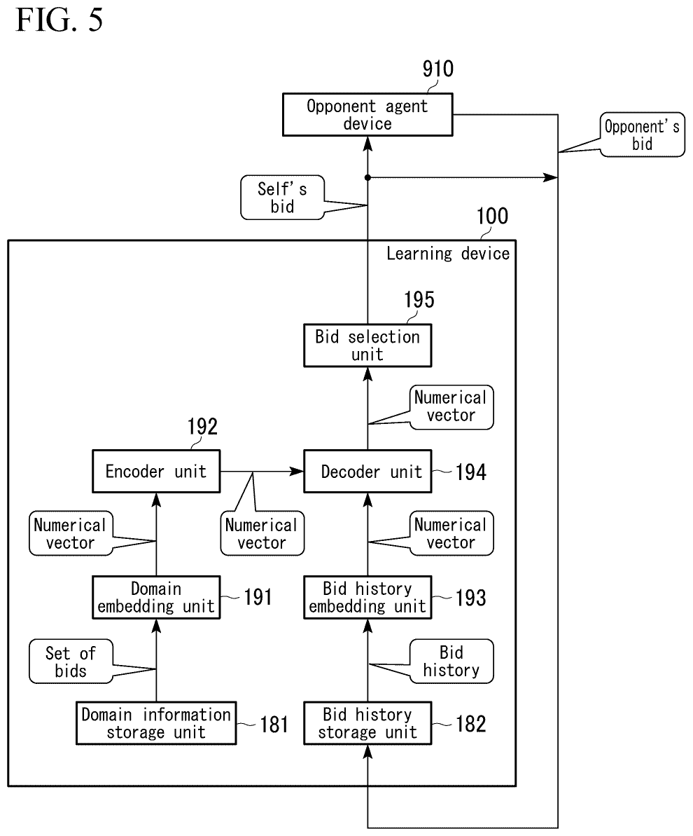

FIG. 5 is a diagram showing an example of data input and output in the proposal generation device 200.

Comparing the example of FIG. 5 with the example of FIG. 3, in the example of FIG. 5, the proposal generation device 200 does not include the value calculation unit 196, and the decoder unit 194 outputs a numerical vector to the bid selection unit 195, but does not output a numerical vector to the value calculation unit 196. In all other respects, the example of FIG. 5 is the same as the example of FIG. 3.

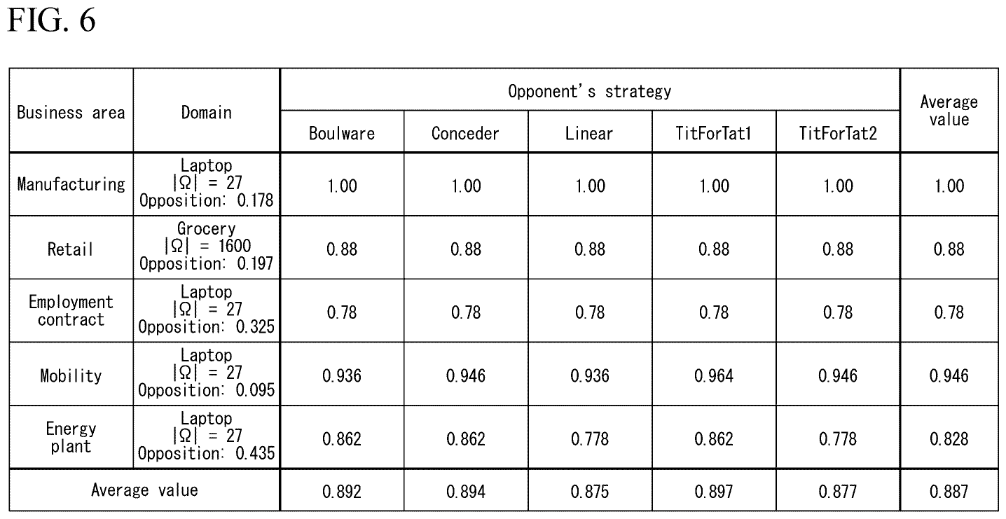

FIG. 6 is a diagram showing the results of an experiment performed using the proposal generation device 200.

A single learning device 100 was subjected to learning by application to a plurality of fields and a plurality of opponent strategies. Further, using the trained learning device 100 as the proposal generation device 200, negotiations were conducted for each of the combinations of the five fields and five opponent strategies shown in FIG. 6, and the negotiation results were then evaluated. In FIG. 6, the evaluation value for the negotiation result is shown as a real number within the range of 0 to 1. A larger evaluation value indicates a better evaluation.

Good evaluation results were obtained for all combinations of fields and opponent strategies.

As described above, the domain embedding unit 191 converts, for each of one or more items defined as an item of a proposal target, each of all possible bids, a bid being a combination of the item and a single proposal option among proposal options that are selectable proposal contents for the item, into a numerical vector capable of identifying the bid.

The bid history embedding unit 193 converts each bid included in a history of bids in a negotiation into a numerical vector capable of identifying the bids.

The combination of the encoder unit 192, the decoder unit 194, and the bid selection unit 195 determines, using the numerical vector into which each of all possible bids has been converted, and the numerical vector into which each bid included in the history of bids has been converted, a bid from among all possible bids to propose to an opponent.

According to the proposal generation device 200, the same model can be used in common for negotiations in different fields. Specifically, with the proposal generation device 200, a bid (proposal) can be determined without the need to specify the domain (field of negotiation) and the strategy of the negotiation opponent, and a single proposal generation device 200 can be used for various domains and various strategies of the negotiation opponent. In particular, according to the proposal generation device 200, a bid can be determined even when the domain and the strategy of the negotiation opponent are unknown. Furthermore, according to the proposal generation device 200, a bid can be determined even for a domain and a strategy of the negotiation opponent that have not been learned.

In addition, the domain embedding unit 191 converts, for each combination of a proposal target item and a proposal option included in a bid, each of the proposal target item and the proposal option into a numerical value as a result of being input to an embedding function, being a function that converts both the proposal target item and the proposal option into an identifiable numerical value, and takes a linear sum of the numerical value into which the proposal target item has been converted and the numerical value into which the proposal option has been converted, causing each of all possible bids to be converted into a numerical vector.

The bid history embedding unit 193 converts each bid included in the history of bids into a numerical vector using the same conversion method as the conversion method performed by the domain embedding unit 191 that converts bids into a numerical vector.

According to the proposal generation device 200, it is expected that the computational load will be relatively small in that a simple calculation of taking a linear sum of the numerical values obtained by converting the proposal target items and the numerical values obtained by converting the proposal options, is performed.

In addition, the bid history embedding unit 193 converts each bid included in a history of bids, which includes both the bids by the proposal generation device 200 and the bids by the negotiation opponent, into a numerical vector.

According to the proposal generation device 200, a bid can be determined based on the history of both the bids by the proposal generation device 200 and the bids by the negotiation opponent. According to the proposal generation device 200, in this respect, it is expected that the determination of a bid can be performed with relatively high precision.

Here, performing the determination of a bid with high precision may mean that the obtained reward is large (the evaluation indicated by the reward is high).

Also, the domain embedding unit 191 converts, for each of one or more items defined as an item of a proposal target, each of all possible bids, a bid being a combination of the item and a single proposal option from among proposal options that are selectable proposal contents for the item, into a numerical vector capable of identifying the bids.

The bid history embedding unit 193 converts each bid included in a history of bids in a negotiation into a numerical vector capable of identifying the bids.

The combination of the encoder unit 192, the decoder unit 194, and the bid selection unit 195 determines, using the numerical vector into which each of all possible bids has been converted, and the numerical vector into which each bid included in the history of bids has been converted, a bid from among all possible bids to propose to an opponent.

The learning processing unit 197 learns a bid determination method performed by the combination of the encoder unit 192, the decoder unit 194, and the bid selection unit 195.

According to the learning device 100, learning can be performed by the same model in common for negotiations in different fields, and the same model can be used in common for negotiations in different fields. Specifically, with the learning device 100, learning for the determination of a bid (proposal) can be performed without the need to specify the domain (field of negotiation) and the strategy of the negotiation opponent, and a single learning device 100 can be used to perform learning for various domains and various strategies of the negotiation opponent. By using a model trained by the learning device 100, a bid can be determined even when the domain and the strategy of the negotiation opponent are unknown. Furthermore, by using a model trained by the learning device 100, a bid can be determined even for a domain and a strategy of the negotiation opponent that have not been learned.

In addition, the domain embedding unit 191 converts, for each combination of a proposal target item and a proposal option included in a bid, each of the proposal target item and the proposal option into a numerical value as a result of being input to an embedding function, being a function that converts both the proposal target item and the proposal option into an identifiable numerical value, and takes a linear sum of the numerical value into which the proposal target item has been converted and the numerical value into which the proposal option has been converted, causing each of all possible bids to be converted into a numerical vector.

The bid history embedding unit 193 converts each bid included in the history of bids into a numerical vector using the same conversion method as the conversion method performed by the domain embedding unit 191 that converts a bid into a numerical vector.

According to the learning device 100, it is expected that the computational load will be relatively small in that a simple calculation of taking a linear sum of the numerical values obtained by converting the proposal target items and the numerical values obtained by converting the proposal options, is performed.

In addition, the bid history embedding unit 193 converts each bid included in a history of bids, which includes both the bids by the learning device 100 and the bids by the negotiation opponent, into a numerical vector.

By using a model trained by the learning device 100, a bid can be determined based on the history of both the bids by the learning device 100 and the bids by the negotiation opponent. By using a model trained by the learning device 100, in this respect, it is expected that the determination of a bid can be performed with relatively high precision.

Both the learning device 100 and the proposal generation device 200 can be used for negotiation of routes in autonomous driving of mobile bodies such as automobiles. The learning device 100 or the proposal generation device 200 may negotiate a route with a mobile body on an opponent side, and yield the route to each other. Then, the mobile body may automatically proceed along the route determined by the negotiation.

Both the learning device 100 and the proposal generation device 200 can be used for the control of robots in a warehouse or the like. The learning device 100 or the proposal generation device 200 may negotiate an inventory adjustment in a manufacturing process, and control a robot according to a determined inventory plan. Also, the learning device 100 or the proposal generation device 200 may negotiate a shipping plan, and control a robot according to a determined shipping plan.

The learning device 100 or the proposal generation device 200 may interact with a person to coordinate a schedule. For example, the learning device 100 or the proposal generation device 200 may plan a flight, or may coordinate a date and time for a visit to a customer. Also, the learning device 100 or the proposal generation device 200 may coordinate a delivery date and time with a recipient of a package. In addition, the learning device 100 or the proposal generation device 200 may determine a delivery plan for a package, such as a delivery route and delivery time of the package, based on the determined delivery date and time.

For both the learning device 100 and the proposal generation device 200, the negotiation opponent may be a person, or a system or device configured using a model such as a Large Language Model (LLM).

By providing the learning device 100 or the proposal generation device 200 with an interface corresponding to the negotiation opponent (which may be a user interface or a communication interface), it becomes possible to perform various coordination with various negotiation opponents such as people, robots, mobile bodies, or artificial intelligence.

### Second Example Embodiment

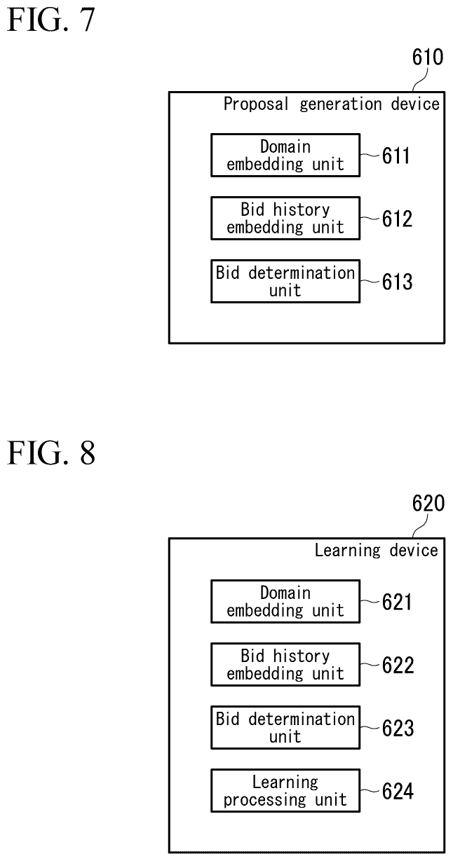

FIG. 7 is a diagram showing an example of a configuration of a proposal generation device according to at least one example embodiment. In the configuration shown in FIG. 7, the proposal generation device 610 includes a domain embedding unit 611, a bid history embedding unit 612, and a bid determination unit 613.

In this configuration, the domain embedding unit 611 converts, for each of one or more items defined as an item of a proposal target, each of all possible bids, a bid being a combination of the item with a single proposal option from among proposal options that are selectable proposal contents for the item, into a numerical vector capable of identifying the bids.

The bid history embedding unit 612 converts each bid included in the history of bids in a negotiation into a numerical vector capable of identifying the bids.

The bid determination unit 613 determines, using the numerical vector into which each of all possible bids has been converted, and the numerical vector into which each bid included in the history of bids has been converted, a bid from among all possible bids to propose to an opponent.

The domain embedding unit 611 corresponds to an example of a domain embedding means. The bid history embedding unit 612 corresponds to an example of a bid history embedding means. The bid determination unit 613 corresponds to an example of a bid determination means.

According to the proposal generation device 610, the same model can be commonly used for negotiations in different fields. Specifically, with the proposal generation device 610, a bid (proposal) can be determined without the need to specify the domain (field of negotiation) and the strategy of the negotiation opponent, and a single proposal generation device 610 can be used for various domains and various strategies of the negotiation opponent. In particular, according to the proposal generation device 610, a bid can be determined even when the domain and the strategy of the negotiation opponent are unknown. Furthermore, according to the proposal generation device 610, a bid can be determined even for a domain and a strategy of the negotiation opponent that have not been learned.

The domain embedding unit 611 can be realized, for example, using the functions of the domain embedding unit 191 and the like of FIG. 4. The bid history embedding unit 612 can be realized, for example, using the functions of the bid history embedding unit 193 and the like of FIG. 4. The bid determination unit 613 can be realized, for example, using the functions of the encoder unit 192, the decoder unit 194, the bid selection unit 195, and the like, of FIG. 4.

### Third Example Embodiment

FIG. 8 is a diagram showing an example of a configuration of a learning device according to at least one example embodiment.

In the configuration shown in FIG. 8, the learning device 620 includes a domain embedding unit 621, a bid history embedding unit 622, a bid determination unit 623, and a learning processing unit 624.

In this configuration, the domain embedding unit 621 converts, for each of one or more items defined as an item of a proposal target, each of all possible bids, a bid being a combination of the item and a single proposal option from among proposal options that are selectable proposal contents for the item, into a numerical vector capable of identifying the bids.

The bid history embedding unit 622 converts each bid included in the history of bids in a negotiation into a numerical vector capable of identifying the bids.

The bid determination unit 623 determines, from among all possible bids, using the numerical vector into which each of all possible bids has been converted, and the numerical vector into which each bid included in the history of bids has been converted, a bid to propose to an opponent.

The learning processing unit 624 learns a bid determination method performed by the bid determination unit 623.

The domain embedding unit 621 corresponds to an example of a domain embedding means. The bid history embedding unit 622 corresponds to an example of a bid history embedding means. The bid determination unit 623 corresponds to an example of a bid determination means. The learning processing unit 624 corresponds to an example of a learning processing means.

According to the learning device 620, learning can be performed by the same model in common for negotiations in different fields, and the same model can be used in common for negotiations in different fields. Specifically, with the learning device 620, learning for the determination of a bid (proposal) can be performed without the need to specify the domain (field of negotiation) and the strategy of the negotiation opponent, and a single learning device 620 can be used to perform learning for various domains and various strategies of the negotiation opponent. By using a model trained by the learning device 620, a bid can be determined even when the domain and the strategy of the negotiation opponent are unknown. Furthermore, by using a model trained by the learning device 620, a bid can be determined even for a domain and a strategy of the negotiation opponent that have not been learned.

The domain embedding unit 621 can be realized, for example, using the functions of the domain embedding unit 191 and the like of FIG. 1. The bid history embedding unit 622 can be realized, for example, using the functions of the bid history embedding unit 193 and the like of FIG. 1. The bid determination unit 623 can be realized, for example, using the functions of the encoder unit 192, the decoder unit 194, the bid selection unit 195, and the like, of FIG. 1. The learning processing unit 624 can be realized, for example, using the functions of the learning processing unit 197 and the like of FIG. 1.

### Fourth Example Embodiment

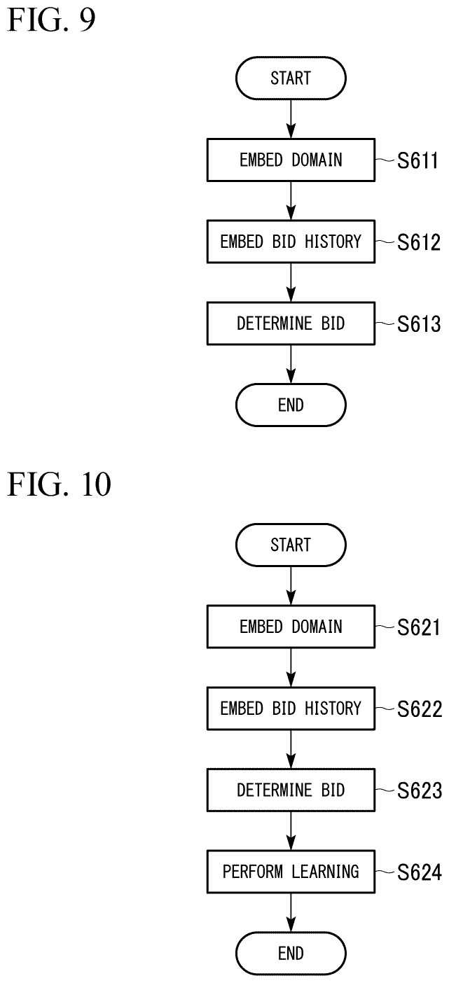

FIG. 9 is a diagram showing an example of a processing procedure of a proposal generation method according to at least one example embodiment. The proposal generation method shown in FIG. 9 includes embedding a domain (step S611), embedding a bid history (step S612), and determining a bid (step S613).

In the step of embedding a domain (step S611) a computer converts, for each of one or more items defined as an item of a proposal target, each of all possible bids, a bid being a combination of the item and a single proposal option from among proposal options that are selectable proposal contents for the item, into a numerical vector capable of identifying the bids.

In the step of embedding a bid history (step S612), a computer converts each bid included in the history of bids in a negotiation into a numerical vector capable of identifying the bids. In the step of determining a bid (step S613), a computer determines, using the numerical vector into which each of all possible bids has been converted, and the numerical vector into which each bid included in the history of bids has been converted, a bid from among all possible bids to propose to an opponent.

According to the proposal generation method shown in FIG. 9, the same model can be used in common for negotiations in different fields. Specifically, with the proposal generation method shown in FIG. 9, a bid (proposal) can be determined without the need to specify the domain (field of negotiation) and the strategy of the negotiation opponent, and a single computer can be used for various domains and various strategies of the negotiation opponent. In particular, according to the proposal generation method shown in FIG. 9, a bid can be determined even when the domain and the strategy of the negotiation opponent are unknown. Furthermore, according to the proposal generation method shown in FIG. 9, a bid can be determined even for a domain and a strategy of the negotiation opponent that have not been learned.

### Fifth Example Embodiment

FIG. 10 is a diagram showing an example of a processing procedure of a learning method according to at least one example embodiment. The learning method shown in FIG. 10 includes embedding a domain (step S621), embedding a bid history (step S622), determining a bid (step S623), and performing learning (step S624).

In the step of embedding a domain (step S621) a computer converts, for each of one or more items defined as an item of a proposal target, each of all possible bids, a bid being a combination of the item and a single proposal option from among proposal options that are selectable proposal contents for the item, into a numerical vector capable of identifying the bids.

In the step of embedding a bid history (step S622), a computer converts each bid included in the history of bids in a negotiation into a numerical vector capable of identifying the bids.

In the step of determining a bid (step S623), a computer determines, using the numerical vector into which each of all possible bids has been converted, and the numerical vector into which each bid included in the history of bids has been converted, a bid from among all possible bids to propose to an opponent.

In the step of performing learning (Step S624), a computer learns the bid determination method.

According to the learning method shown in FIG. 10, learning can be performed by the same model in common for negotiations in different fields, and the same model can be used in common for negotiations in different fields. Specifically, with the learning method shown in FIG. 10, learning for the determination of a bid (proposal) can be performed without the need to specify the domain (field of negotiation) and the strategy of the negotiation opponent, and a single computer can be used to perform learning for various domains and various strategies of the negotiation opponent. By using a model trained by the learning method shown in FIG. 10, a bid can be determined even when the domain and the strategy of the negotiation opponent are unknown. Furthermore, by using a model trained by the learning method shown in FIG. 10, a bid can be determined even for a domain and a strategy of the negotiation opponent that have not been learned.

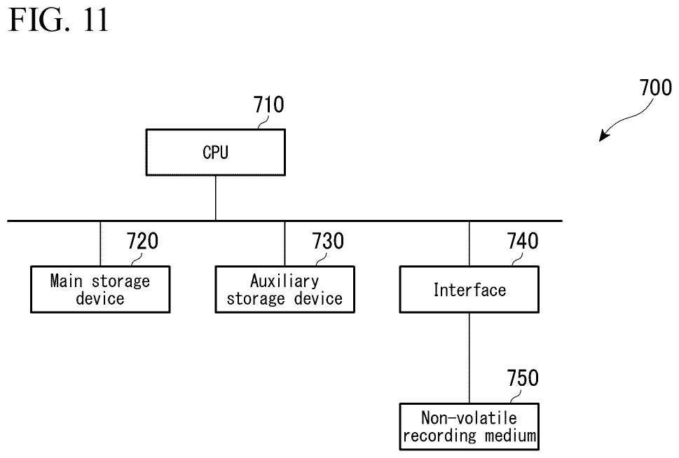

FIG. 11 is a schematic block diagram showing a configuration of a computer according to at least one example embodiment.

In the configuration shown in FIG. 11, a computer 700 includes a CPU 710, a main storage device 720, an auxiliary storage device 730, an interface 740, and a non-volatile recording medium 750.

Any one or more of the learning device 100, the proposal generation device 200, the proposal generation device 610, and the learning device 620, or a portion thereof, may be implemented by the computer 700. In this case, the operation of each of the processing units described above is stored in the auxiliary storage device 730 in the form of a program. The CPU 710 reads the program from the auxiliary storage device 730, expands the program in the main storage device 720, and executes the processing described above according to the program. Moreover, the CPU 710 secures a storage area corresponding to each of the storage units in the main storage device 720 according to the program. The communication of each device with other devices is executed as a result of the interface 740 having a communication function and performing communication according to the control of the CPU 710. Furthermore, the interface 740 includes a port for the non-volatile recording medium 750, and reads information from the non-volatile recording medium 750 and writes information to the non-volatile recording medium 750.

When the learning device 100 is implemented by the computer 700, the operation of the processing unit 190 and each of the units thereof is stored in the auxiliary storage device 730 in the form of a program. The CPU 710 reads the program from the auxiliary storage device 730, expands the program in the main storage device 720, and executes the processing described above according to the program.

Furthermore, the CPU 710 secures a storage area for the storage unit 180 in the main storage device 720 according to the program. The communication by the communication unit 110 with other devices is executed as a result of the interface 740 including a communication function and operating under the control of the CPU 710. The display of images by the display unit 120 is executed as a result of the interface 740 including a display device, and displaying various images under the control of the CPU 710. The acceptance of user operations by the operation input unit 130 is executed as a result of the interface 740 including an input device, and accepting user operations under the control of the CPU 710.

When the proposal generation device 200 is implemented by the computer 700, the operation of the processing unit 290 and each of the units thereof is stored in the auxiliary storage device 730 in the form of a program. The CPU 710 reads the program from the auxiliary storage device 730, expands the program in the main storage device 720, and executes the processing described above according to the program.

Furthermore, the CPU 710 secures a storage area for the storage unit 180 in the main storage device 720 according to the program. The communication by the communication unit 110 with other devices is executed as a result of the interface 740 including a communication function and operating under the control of the CPU 710. The display of images by the display unit 120 is executed as a result of the interface 740 including a display device, and displaying various images under the control of the CPU 710. The acceptance of user operations by the operation input unit 130 is executed as a result of the interface 740 including an input device, and accepting user operations under the control of the CPU 710.

When the proposal generation device 610 is implemented by the computer 700, the operation of the domain embedding unit 611, the bid history embedding unit 612, and the bid determination unit 613, is stored in the auxiliary storage device 730 in the form of a program. The CPU 710 reads the program from the auxiliary storage device 730, expands the program in the main storage device 720, and executes the processing described above according to the program.

Furthermore, the CPU 710 secures a storage area in the main storage device 720 for the proposal generation device 610 to perform processing according to the program. The communication between the proposal generation device 610 and other devices is executed as a result of the interface 740 including a communication function and operating under the control of the CPU 710. The interactions between the proposal generation device 610 and the user is executed as a result of the interface 740 having an input device and an output device, presenting information to the user through the output device under the control of the CPU 710, and accepting user operations through the input device.

When the learning device 620 is implemented by the computer 700, the operation of the domain embedding unit 621, the bid history embedding unit 622, the bid determination unit 623, and the learning processing unit 624 is stored in the auxiliary storage device 730 in the form of a program. The CPU 710 reads the program from the auxiliary storage device 730, expands the program in the main storage device 720, and executes the processing described above according to the program.

Furthermore, the CPU 710 secures a storage area in the main storage device 720 for the learning device 620 to perform processing according to the program. The communication between the learning device 620 and other devices is executed as a result of the interface 740 including a communication function and operating under the control of the CPU 710. The interactions between the learning device 620 and the user is executed as a result of the interface 740 having an input device and an output device, presenting information to the user through the output device under the control of the CPU 710, and accepting user operations through the input device.

One or more of the programs described above may be recorded in the non-volatile recording medium 750. In this case, the interface 740 may read out the program from the non-volatile recording medium 750. Then, the CPU 710 may directly execute the program that has been read out by the interface 740, or execute the program after temporarily saving the program in the main storage device 720 or the auxiliary storage device 730.

Furthermore, a program for executing some or all of the processing performed by the learning device 100, the proposal generation device 200, the proposal generation device 610, and the learning device 620 may be recorded in a computer-readable recording medium, and the processing of each unit may be performed by a computer system reading and executing the program recorded on the recording medium. The “computer system” referred to here is assumed to include an OS (operating system) and hardware such as a peripheral device.

Furthermore, the “computer-readable recording medium” refers to a portable medium such as a flexible disk, a magnetic optical disk, a ROM (read only memory), or a CD-ROM (compact disc read only memory), or a storage device such as a hard disk built into a computer system. Moreover, the program may be one capable of realizing some of the functions described above. In addition, the functions described above may be realized in combination with a program already recorded in the computer system.

The present disclosure has been described above with reference to the example embodiments. However, the present disclosure is not limited to the example embodiments described above. Various changes to the configuration and details of the present disclosure that can be understood by those skilled in the art can be made within the scope of the present disclosure. In addition, the example embodiments described above may be combined as appropriate with other example embodiments.

The whole or part of the example embodiments above can be described as the supplementary notes below, but the example embodiments are not limited thereto.

### (Supplementary Note 1)

A proposal generation device comprising:
a memory configured to store instructions; and
a processor configured to execute the instructions to:
   convert, for each of one or more items defined as an item of a proposal target, each of all possible bids each of which is a bid being a combination of the item and a single proposal option among proposal options that are selectable proposal contents for the item, into a numerical vector capable of identifying the bids;
   convert each bid included in a history of bids in a negotiation into a numerical vector capable of identifying the bid; and
   determine, using the numerical vector into which each of all possible bids has been converted, and the numerical vector into which each bid included in the history of bids has been converted, a bid to be proposed to a negotiation opponent, from among all possible bids.

### (Supplementary Note 2)

The proposal generation device according to supplementary note 1,
wherein converting each of all possible bids comprises:
converting, for each combination of a proposal target item and a proposal option included in a bid, each of the proposal target item and the proposal option into a numerical value as a result of being input to a function that converts both the proposal target item and the proposal option into an identifiable numerical value; and
taking a linear sum of the numerical value into which the proposal target item has been converted and the numerical value into which the proposal option has been converted, causing each of all possible bids to be converted into a numerical vector, and
wherein converting each bid included in the history of the bids in the negotiation comprises converting each bid included in the history of the bids into the numerical vector using a conversion method that is same as a method of converting each of all possible bids into the numerical vector.

### (Supplementary Note 3)

The proposal generation device according to supplementary note 1 or 2, wherein converting each bid included in the history of the bids in the negotiation comprises converting each bid included in the history of the bids, which includes both bids by the proposal generation device and bids by the negotiation opponent, into a numerical vector.

### (Supplementary Note 4)

A learning device comprising:
a memory configured to store instructions; and
a processor configured to execute the instructions to:
   convert, for each of one or more items defined as an item of a proposal target, each of all possible bids each of which is a bid being a combination of the item and a single proposal option among proposal options that are selectable proposal contents for the item, into a numerical vector capable of identifying the bids;
   convert each bid included in a history of bids in a negotiation into a numerical vector capable of identifying the bid;
   determine, using the numerical vector into which each of all possible bids has been converted, and the numerical vector into which each bid included in the history of bids has been converted, a bid to be proposed to a negotiation opponent, from among all possible bids; and
   learning a method of determining the bid to be proposed to the negotiation opponent.

### (Supplementary Note 5)

The learning device according to supplementary note 4,
wherein converting each of all possible bids comprises:
converting, for each combination of a proposal target item and a proposal option included in a bid, each of the proposal target item and the proposal option into a numerical value as a result of being input to a function that converts both the proposal target item and the proposal option into an identifiable numerical value; and
taking a linear sum of the numerical value into which the proposal target item has been converted and the numerical value into which the proposal option has been converted, causing each of all possible bids to be converted into a numerical vector, and
wherein converting each bid included in the history of the bids in the negotiation comprises converting each bid included in the history of the bids into the numerical vector using a conversion method that is same as a method of converting each of all possible bids into the numerical vector.

### (Supplementary Note 6)

The learning device according to supplementary note 4 or 5, wherein converting each bid included in the history of the bids in the negotiation comprises converting each bid included in the history of the bids, which includes both bids by the proposal generation device and bids by the negotiation opponent, into a numerical vector.

### (Supplementary Note 7)

A proposal generation method executed by a computer, comprising:
converting, for each of one or more items defined as an item of a proposal target, each of all possible bids each of which is a bid being a combination of the item and a single proposal option among proposal options that are selectable proposal contents for the item, into a numerical vector capable of identifying the bids;
converting each bid included in a history of bids in a negotiation into a numerical vector capable of identifying the bid; and
determining, using the numerical vector into which each of all possible bids has been converted, and the numerical vector into which each bid included in the history of bids has been converted, a bid to be proposed to a negotiation opponent, from among all possible bids.

### (Supplementary Note 8)

The proposal generation method according to supplementary note 7,
wherein converting each of all possible bids comprises:
converting, for each combination of a proposal target item and a proposal option included in a bid, each of the proposal target item and the proposal option into a numerical value as a result of being input to a function that converts both the proposal target item and the proposal option into an identifiable numerical value; and
taking a linear sum of the numerical value into which the proposal target item has been converted and the numerical value into which the proposal option has been converted, causing each of all possible bids to be converted into a numerical vector, and
wherein converting each bid included in the history of the bids in the negotiation comprises converting each bid included in the history of the bids into the numerical vector using a conversion method that is same as a method of converting each of all possible bids into the numerical vector.

### (Supplementary Note 9)

The proposal generation method according to supplementary note 7 or 8, wherein converting each bid included in the history of the bids in the negotiation comprises converting each bid included in the history of the bids, which includes both bids by the computer itself and bids by the negotiation opponent, into a numerical vector.

### (Supplementary Note 10)

A learning method executed by a computer, comprising:
converting, for each of one or more items defined as an item of a proposal target, each of all possible bids each of which is a bid being a combination of the item and a single proposal option among proposal options that are selectable proposal contents for the item, into a numerical vector capable of identifying the bids;
converting each bid included in a history of bids in a negotiation into a numerical vector capable of identifying the bid;
determining, using the numerical vector into which each of all possible bids has been converted, and the numerical vector into which each bid included in the history of bids has been converted, a bid to be proposed to a negotiation opponent, from among all possible bids; and
learning a method of determining the bid to be proposed to the negotiation opponent.

### (Supplementary Note 11)

The learning method according to supplementary note 10,
wherein converting each of all possible bids comprises:
converting, for each combination of a proposal target item and a proposal option included in a bid, each of the proposal target item and the proposal option into a numerical value as a result of being input to a function that converts both the proposal target item and the proposal option into an identifiable numerical value; and
taking a linear sum of the numerical value into which the proposal target item has been converted and the numerical value into which the proposal option has been converted, causing each of all possible bids to be converted into a numerical vector, and
wherein converting each bid included in the history of the bids in the negotiation comprises converting each bid included in the history of the bids into the numerical vector using a conversion method that is same as a method of converting each of all possible bids into the numerical vector.

### (Supplementary Note 12)

The learning method according to supplementary note 10 or 11, wherein converting each bid included in the history of the bids in the negotiation comprises converting each bid included in the history of the bids, which includes both bids by the proposal generation device and bids by the negotiation opponent, into a numerical vector.

### (Supplementary Note 13)

A program that causes a computer to execute:
converting, for each of one or more items defined as an item of a proposal target, each of all possible bids each of which is a bid being a combination of the item and a single proposal option among proposal options that are selectable proposal contents for the item, into a numerical vector capable of identifying the bids;
converting each bid included in a history of bids in a negotiation into a numerical vector capable of identifying the bid; and
determining, using the numerical vector into which each of all possible bids has been converted, and the numerical vector into which each bid included in the history of bids has been converted, a bid to be proposed to a negotiation opponent, from among all possible bids.

The program may be stored in a non-transitory computer readable recording medium.

### (Supplementary Note 14)

The program according to supplementary note 13,
wherein converting each of all possible bids comprises:
converting, for each combination of a proposal target item and a proposal option included in a bid, each of the proposal target item and the proposal option into a numerical value as a result of being input to a function that converts both the proposal target item and the proposal option into an identifiable numerical value; and
taking a linear sum of the numerical value into which the proposal target item has been converted and the numerical value into which the proposal option has been converted, causing each of all possible bids to be converted into a numerical vector, and
wherein converting each bid included in the history of the bids in the negotiation comprises converting each bid included in the history of the bids into the numerical vector using a conversion method that is same as a method of converting each of all possible bids into the numerical vector.

### (Supplementary Note 15)

The program according to supplementary note 13 or 14, wherein converting each bid included in the history of the bids in the negotiation comprises converting each bid included in the history of the bids, which includes both bids by the proposal generation device and bids by the negotiation opponent, into a numerical vector.

### (Supplementary Note 16)

A program that causes a computer to execute:
converting, for each of one or more items defined as an item of a proposal target, each of all possible bids each of which is a bid being a combination of the item and a single proposal option among proposal options that are selectable proposal contents for the item, into a numerical vector capable of identifying the bids;
converting each bid included in a history of bids in a negotiation into a numerical vector capable of identifying the bid;
determining, using the numerical vector into which each of all possible bids has been converted, and the numerical vector into which each bid included in the history of bids has been converted, a bid to be proposed to a negotiation opponent, from among all possible bids; and
learning a method of determining the bid to be proposed to the negotiation opponent.

The program may be stored in a non-transitory computer readable recording medium.

### (Supplementary Note 17)

The program according to supplementary note 16,
wherein converting each of all possible bids comprises:
converting, for each combination of a proposal target item and a proposal option included in a bid, each of the proposal target item and the proposal option into a numerical value as a result of being input to a function that converts both the proposal target item and the proposal option into an identifiable numerical value; and
taking a linear sum of the numerical value into which the proposal target item has been converted and the numerical value into which the proposal option has been converted, causing each of all possible bids to be converted into a numerical vector, and
wherein converting each bid included in the history of the bids in the negotiation comprises converting each bid included in the history of the bids into the numerical vector using a conversion method that is same as a method of converting each of all possible bids into the numerical vector.

### (Supplementary Note 18)

The program according to supplementary note 16 or 17, wherein converting each bid included in the history of the bids in the negotiation comprises converting each bid included in the history of the bids, which includes both bids by the proposal generation device and bids by the negotiation opponent, into a numerical vector.

What is claimed is:

1. A proposal generation device comprising:
a memory configured to store instructions; and
a processor configured to execute the instructions to:
convert, for each of one or more items defined as an item of a proposal target, each of all possible bids each of which is a bid being a combination of the item and a single proposal option among proposal options that are selectable proposal contents for the item, into a numerical vector capable of identifying the bids;
convert each bid included in a history of bids in a negotiation into a numerical vector capable of identifying the bid; and
determine, using the numerical vector into which each of all possible bids has been converted, and the numerical vector into which each bid included in the history of bids has been converted, a bid to be proposed to a negotiation opponent, from among all possible bids.

2. The proposal generation device according to claim 1,
wherein converting each of all possible bids comprises:
converting, for each combination of a proposal target item and a proposal option included in a bid, each of the proposal target item and the proposal option into a numerical value as a result of being input to a function that converts both the proposal target item and the proposal option into an identifiable numerical value; and
taking a linear sum of the numerical value into which the proposal target item has been converted and the numerical value into which the proposal option has been converted, causing each of all possible bids to be converted into a numerical vector, and
wherein converting each bid included in the history of the bids in the negotiation comprises converting each bid included in the history of the bids into the numerical vector using a conversion method that is same as a method of converting each of all possible bids into the numerical vector.

3. The proposal generation device according to claim 1, wherein converting each bid included in the history of the bids in the negotiation comprises converting each bid included in the history of the bids, which includes both bids by the proposal generation device and bids by the negotiation opponent, into a numerical vector.

4. A learning device comprising:
a memory configured to store instructions; and
a processor configured to execute the instructions to:
convert, for each of one or more items defined as an item of a proposal target, each of all possible bids each of which is a bid being a combination of the item and a single proposal option among proposal options that are selectable proposal contents for the item, into a numerical vector capable of identifying the bids;
convert each bid included in a history of bids in a negotiation into a numerical vector capable of identifying the bid;
determine, using the numerical vector into which each of all possible bids has been converted, and the numerical vector into which each bid included in the history of bids has been converted, a bid to be proposed to a negotiation opponent, from among all possible bids; and
learn a method of determining the bid to be proposed to the negotiation opponent.

5. The learning device according to claim 4,
wherein converting each of all possible bids comprises:
converting, for each combination of a proposal target item and a proposal option included in a bid, each of the proposal target item and the proposal option into a numerical value as a result of being input to a function that converts both the proposal target item and the proposal option into an identifiable numerical value; and
taking a linear sum of the numerical value into which the proposal target item has been converted and the numerical value into which the proposal option has been converted, causing each of all possible bids to be converted into a numerical vector, and
wherein converting each bid included in the history of the bids in the negotiation comprises converting each bid included in the history of the bids into the numerical vector using a conversion method that is same as a method of converting each of all possible bids into the numerical vector.

6. The learning device according to claim 4, wherein converting each bid included in the history of the bids in the negotiation comprises converting each bid included in the history of the bids, which includes both bids by the proposal generation device and bids by the negotiation opponent, into a numerical vector.

7. A proposal generation method executed by a computer, comprising:
converting, for each of one or more items defined as an item of a proposal target, each of all possible bids each of which is a bid being a combination of the item and a single proposal option among proposal options that are selectable proposal contents for the item, into a numerical vector capable of identifying the bids;
converting each bid included in a history of bids in a negotiation into a numerical vector capable of identifying the bid; and
determining, using the numerical vector into which each of all possible bids has been converted, and the numerical vector into which each bid included in the history of bids has been converted, a bid to be proposed to a negotiation opponent, from among all possible bids.

8. The proposal generation method according to claim 7,
wherein converting each of all possible bids comprises:
converting, for each combination of a proposal target item and a proposal option included in a bid, each of the proposal target item and the proposal option into a numerical value as a result of being input to a function that converts both the proposal target item and the proposal option into an identifiable numerical value; and
taking a linear sum of the numerical value into which the proposal target item has been converted and the numerical value into which the proposal option has been converted, causing each of all possible bids to be converted into a numerical vector, and
wherein converting each bid included in the history of the bids in the negotiation comprises converting each bid included in the history of the bids into the numerical vector using a conversion method that is same as a method of converting each of all possible bids into the numerical vector.

9. The proposal generation method according to claim 7, wherein converting each bid included in the history of the bids in the negotiation comprises converting each bid included in the history of the bids, which includes both bids by the computer itself and bids by the negotiation opponent, into a numerical vector.
